(19) United States
(12) Patent Application Publication
(10) Pub. No.: US 2022/0279753 A1
(43) Pub. Date: Sep. 8, 2022

(54) PET FOOD DISPENSER

(71) Applicant: COMMERCIALISATION EXPRESS PTY LTD, Salisbury Heights (AU)

(72) Inventors: Peter IANNELLA, Salisbury Heights (AU); Michael IANNELLA, Salisbury Heights (AU); Paul IANNELLA, Salisbury Heights (AU); John RIEMELMOSER, Salisbury Heights (AU); Frank IMBROGNO, Salisbury Heights (AU)

(73) Assignee: COMMERCIALISATION EXPRESS PTY LTD, Salisbury Heights (AU)

(21) Appl. No.: 17/631,926

(22) PCT Filed: Aug. 8, 2020
(86) PCT No.: PCT/AU2020/050824

§ 371 Date: Feb. 1, 2022

(30) Foreign Application Priority Data
Aug. 9, 2019 (AU) 2019902851
Oct. 3, 2019 (AU) 2019101211

(51) Int. Cl. A01K 5/01

(52) U.S. Cl. CPC A01K 5/0114

(57) ABSTRACT

A pet food dispenser comprising a cylindrical body with a cutter rotatably attached at one end. A pressure plate threadedly mounted to a rotatable rod extrudes the pet food through the cutter as the rod is turned. Once extruded, the pet food can be cut off by rotation of the cutter. Sealing caps at either end allow any unused food to be stored within the dispenser without emitting odours.

### FIELD OF THE INVENTION

The present invention relates to a dispenser for dispensing pet food, the kind of which comes normally as a roll of meat.

More particularly this invention relates to a new and unique dispenser which will assist in dispensing and cutting such a roll of food into more comfortable portions for eating and to be able to store appropriately the unconsumed roll of food for subsequent further dispensing at later meals.

### BACKGROUND TO THE INVENTION

In order to place this invention in context, the roll of food, which as introduced above for the most part would be made of meat, generally compressed meat, is described as a pet food dispenser.

Nonetheless, this invention in the context of what is being claimed for should not be read so narrowly that the food being dispensed from the dispenser is only that for pets but can be used more generally with other foods if suitable.

In order for a healthy diet for pets, rather than relying upon dried or granulated pellets and blocks of food, fresh meat which is often compressed is made available as a roll of pet food wherein overall this roll of pet food has an appearance of a rather large sausage which is then wrapped in a film to be tied off by an appropriate clamp or twine at each of the respective ends of the roll of pet food.

When served up for consumption for the pet there is the requirement for the film to be at least removed from that portion of the roll of pet food to be eaten so that it can then be chopped up into the requisite blocks of pieces to make it comfortable and safe for the pet to consume.

As is to be envisaged, this does create a troublesome task wherein the roll of pet food has to be cut and chopped up on a chopping block or the like to then be placed in the bowl for serving.

The remaining unconsumed section of the roll of pet food then has to be covered again appropriately so it can be refrigerated.

As the film which originally enclosed the roll of pet food has been for the most part cut away during the first serving of the roll of pet food, even though one may wrap up the roll again in a flexible film, during refrigeration as the film offers limited coverage over the roll of pet food, odours and the like can still emanate.

Accordingly it would be particularly advantageous if there was a better way in which a meal from these kinds of rolls of pet food could be cut into blocks and served directly into the container from which the pet would then consume the meal therefrom.

It would also be advantageous to be able to maintain the freshness of the unconsumed section of the roll of pet food in between meals as it is returned to refrigeration without the adverse effects of the unnecessary release of odours and the like coming from the cut roll of pet food.

Therefore it is an object of this invention to be able to provide an appropriate pet food dispenser arrangement and a method of dispensing the pet food therefrom said arrangement which can overcome the disadvantages of existing arrangements or at least provide an improved alternative in the marketplace for consumers that has hitherto been made available.

Further objects and advantages of this invention will become apparent from a complete reading of the following specification.

### SUMMARY OF THE INVENTION

In a first aspect the invention provides a pet food dispenser comprising a cylindrical body with a first dispensing end and a second non-dispensing end, a threaded rod extending from the dispensing end to the non-dispensing end and rotatably attached to the non-dispensing end, a pressure plate threadedly engaged with the rod, and a rotatable cutter including a plurality of blades rotatably attached to the dispensing end; wherein rotation of the rod moves the pressure plate along the rod pushing extruding the pet food through the rotatable cutter, and wherein rotation of the rotatable cutter cuts off the extruded pet food.

Preferably the cylindrical body and the pressure plate are adapted to prevent rotation of the pressure plate within the cylindrical body. The cylindrical body may comprise a longitudinal rib and the pressure plate a peripheral notch adapted to engage the longitudinal rib.

Preferably the cylindrical body is formed from first and second semi-cylindrical halves releasably attached together, wherein the first and second semi-cylindrical halves comprise longitudinal flanges and are releasably attached together via the flanges.

Preferably the flanges are ribbed.

The pet food dispenser may further comprise a handle with channels adapted to engage with the flanges to attach the flanges together.

In preference the cylindrical body comprises at least one vane adapted to prevent rotation of the pet food.

The pet food dispenser may further comprise a fixed cutter including a plurality of blades fixedly attached to the dispensing end adjacent the rotatable cutter.

Preferably the pet food dispenser further comprises a transparent window along the cylindrical body.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a cross-sectional view of the pet food dispenser arrangement in a first embodiment of the invention.

FIGS. 2A and 2B are perspective views of the pet food dispenser arrangement in the first embodiment of the invention.

FIG. 3 is an exploded view of the pet food dispenser arrangement looking from the dispensing end of the pet food dispenser arrangement to the non-dispensing end of the pet food dispenser arrangement in the first embodiment of the invention.

FIG. 4 is an exploded view similar to that presented in FIG. 3, looking from right to left from the non-dispensing end to the dispensing end of the pet food dispenser arrangement in a first embodiment of the invention.

FIG. 5 shows a perspective view of a pet food dispenser according to a second embodiment of the invention.

FIG. 6 shows a perspective view of the second embodiment of the invention with some components removed to reveal the inner workings of the pet food dispenser.

FIG. 7 shows an exploded view of the dispensing end of the second embodiment of the pet food dispenser.

FIGS. 8A and 8B shows details of the non-dispensing end of the second embodiment of the pet food dispenser.

FIG. 9 shows an exploded view of the body of the second embodiment of the pet food dispenser to illustrate how it is assembled from two halves.

### DRAWING IDENTIFIERS

The drawings include the following integers.
10 pet food dispenser—first embodiment
12 main body
14 rod
16 rotatable section
18 non-dispensing end
19 point
20 dispensing end
22 cap
24 bore hole
25 notches
26 gap
27 glued interface
30 collar
31 upper skirt
34 pressure plate
36 raised collar
38 threads
39 threads
40 intermediate collar
42 fixed cutter
44 turnable collar
46 rotatable cutter
48 seal cap
50 lock assembly
52 tabs
54 ribs
56 window
61 threads
63,65 blades
67,69 central hubs
71,73 openings
72 skirt
75 internal skirt
81 tab
83 rod
84 aperture
88 slot
100 pet food dispenser—second embodiment
101 dispensing end
102 non-dispensing end
105 body
110 first half body
111 flanges
112 ribs
113 vane
120 second half body
121 flanges
125 raceway
130 handle
131 channels
132 tabs
140 clip
141 channels
142 tabs
150 removable cap
155 grip covers
160 collar
170 collar
171 shoulder
180 cutter
181 ring
182 blades
183 hub
184 tabs
185 grips
190 rotating end
195 end grip
200 rod
210 pressure plate
212 notches
213 slots

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The invention provides a pet food dispenser that conveniently stores pet food and allows it to be easily dispensed. Two preferred embodiments of the invention are described below. The first embodiment includes two blades that allow for dispensing of relatively hard food, and a second embodiment with a single blade which is suitable for dispensing relatively soft food. The two embodiments share many features, and the invention readily envisages further embodiments selectively including features from the first two embodiments.

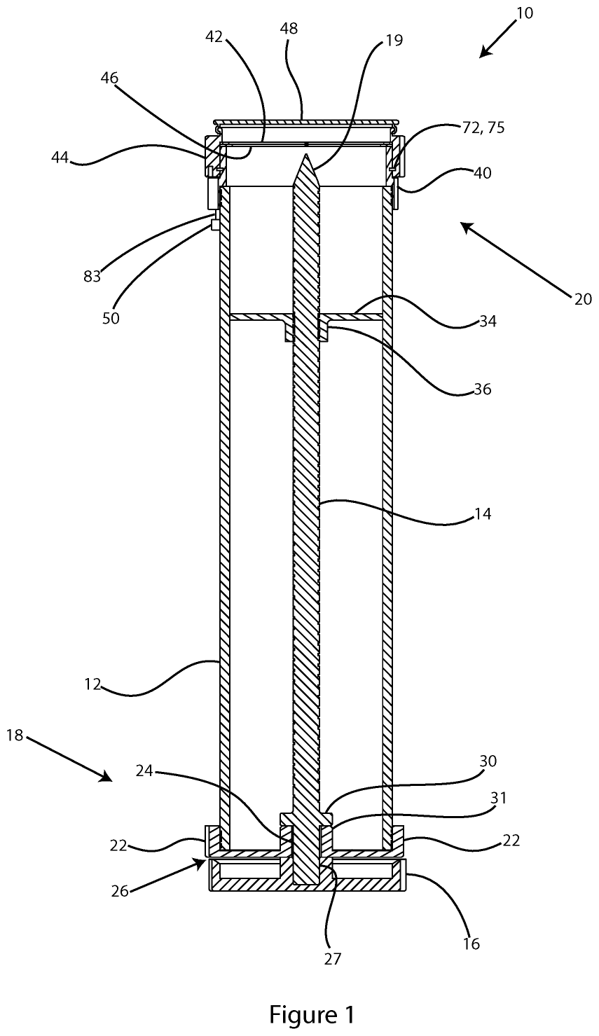

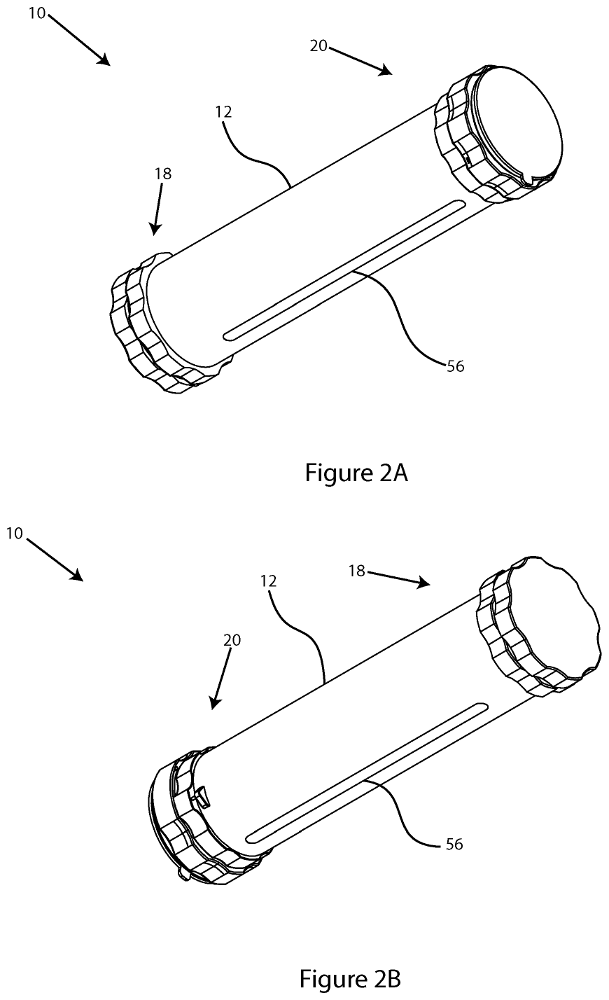

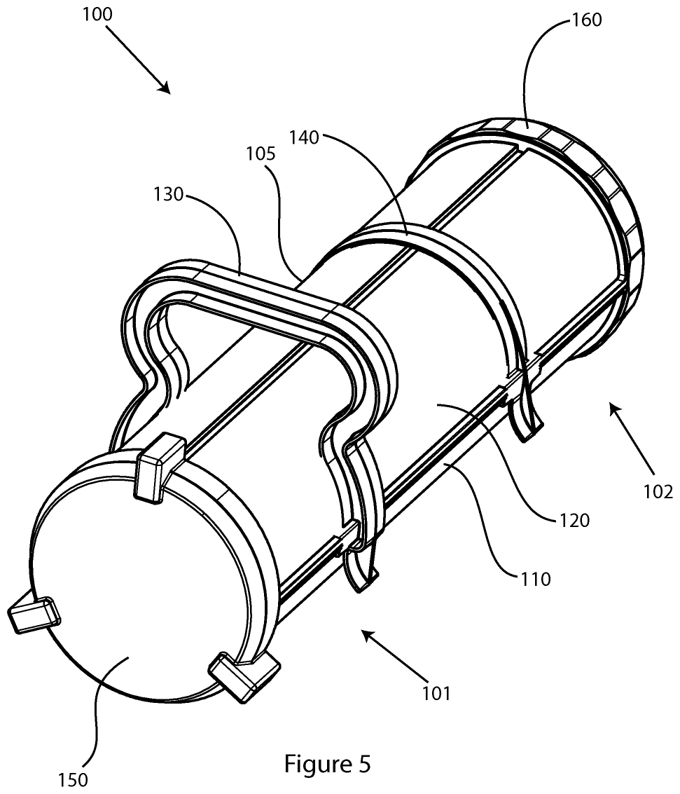

The first embodiment of the invention is described, immediately below in relation to FIGS. 1 to 4, whilst the second embodiment is described further below in relation to FIGS. 5 to 9.

Referring now to FIGS. 1 to 4 in greater detail, the first embodiment of the present invention provides a pet food dispenser arrangement shown generally as (10). As best seen in FIG. 1 the pet food dispenser arrangement (10) includes a main hollow body (12) having a cylindrical shape.

Within the hollow main body there is a rod (14) which is fixed to a user rotatable section (16) which is located at the non-dispensing end (18) of the hollow main body (12).

The non-dispensing end (18) of the hollow main body (12) is capped by way of cap (22) wherein cap (22) also includes a bore hole (24) in through which the rod (14) can pass so as to be centrally fixed to the user-rotatable section (16).

In the preferred embodiment referenced in the illustrations, the rod (14) has a glued interface inside the raised funnel shown as (27) as part of the configuration of the user-rotatable section (16).

Also, the rod (14) at the dispensing end includes a point (19) to assist in inserting the rod (14) into a roll of pet food (not shown).

The cap (22) provides a sealing for the pet food dispenser arrangement (10) at the non-dispensing end (18) of the hollow main body (12).

There is a small clearance gap (26) between the user-rotatable section (16) and the cap (22) which covers the non-dispensing end (18) of the hollow main body (12).

The rod (14) also includes collar (30) which rests upon the upper skirt (31) of the defined bore (24) of the cap (22).

The walls of the bore hole (24) and the upper skirt (31) and its engagement with the collar (30) of the rod (14) assists in providing a degree of structural integrity for the mounting of the rod (14) within the hollow main body (12) of the pet food dispenser arrangement (10).

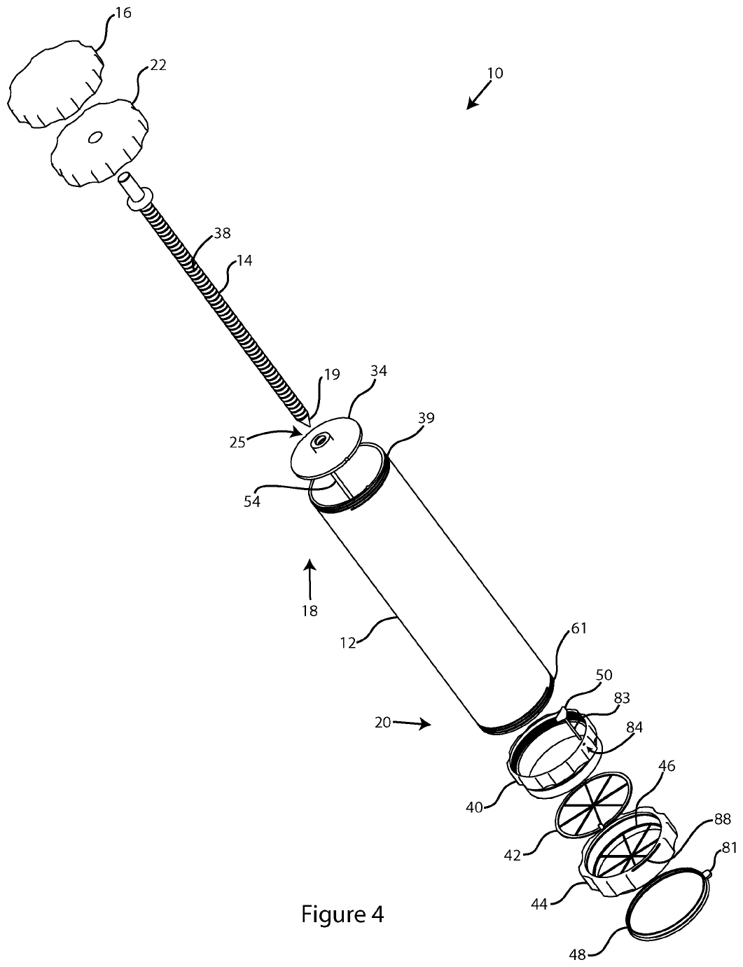

Importantly as part of this invention, there is the pressure plate (34) which as best seen in FIG. 4 also has a raised collar (36). The pressure plate (34) and raised collar (36) include a threading arrangement which matches the threads (38) of the rod (14) such that when the rod (14) rotates when engaged by a user and the pressure plate is placed up against the end of the roll of pet food (not shown) the mechanics of the thread arrangement between the pressure plate (34) and the rod (14) allows the pressure plate to move along the rod (14) towards the dispensing end (20) of the hollow main body (12) of the pet food dispenser arrangement (10).

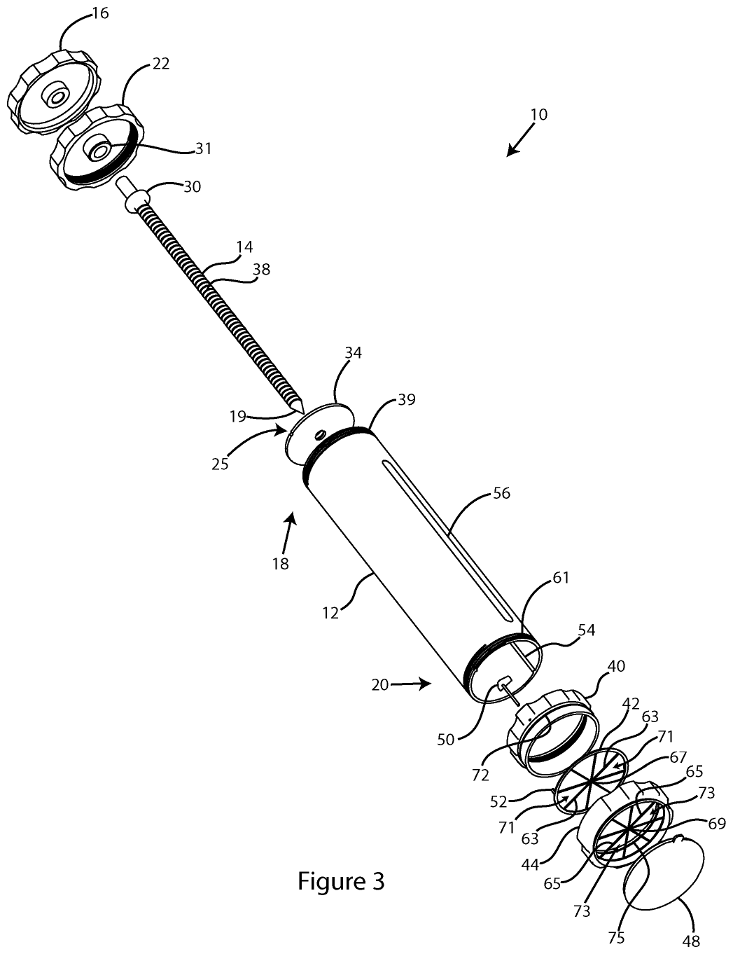

As best seen in FIGS. 3 and 4, at the non-dispensing end (18) of the hollow main body (12) the cap (22) threadedly engages a series of threads (39).

The cutting assembly is made up of a fixed cutter (42) and a rotatable cutter (46).

As best seen in FIGS. 3 and 4, the fixed cutter (42) and the rotatable cutter (46) have a general circular shape with a series of blades (63) on the fixed cutter (42) and blades (65) on the rotatable cutter (46) which radiate towards a central hub or node (67) and (69).

When the blades (63) of cutter (42) align with the blades (65) of cutter (46) this provides an open position, in that a roll of pet food contained within the hollow main body (12) which has been forced down by the pressure plate (34) which is moving down the rod (14) by way of the user-rotatable section (16) being rotated by a user, as the respective blades (63) and (65) of the fixed cutter (42) and the rotatable cutter (46) are aligned then in between those blades (63) and (65) openings (71) and (73) allow for the roll of pet food (not shown) to extrude through the dispensing end (20) of the hollow main body (12) of the pet food dispenser arrangement (10).

When a certain amount of the roll of pet food has made its way through the spaces (71) and (73) between the blades (63) of the fixed cutter (42) and (65) of the rotatable cutter (46) it is then possible to cut these strips of extruded pet food from the roll of pet food into pieces or blocks rather than continuous lengths such as a piece of spaghetti or the like.

The relative movement between the fixed cutter (42) and the rotatable cutter (46) slices the extruded lengths of the roll of pet food as the respective blades (63) and (65) slide across each other during the relative movement.

In the first embodiment shown as best seen in FIGS. 3 and 4, the fixed cutter (42) is fixedly located to the intermediate collar (40) with the aid of tabs (52), whilst the rotatable cutter (46) is fixedly located to the turnable collar (44) which is free to rotate with respect to the intermediate collar (40).

The main body (12) includes internal raised ribs or ridges (54) which engage with corresponding notches (25) of the pressure plate (34), preventing the pressure plate from rotating. This ensures that as the rod (14) rotates the threadedly engaged pressure plate moves along the rod (14) and pushes the end of the roll of pet food towards the dispensing end (20) of the hollow main body (12).

As seen in FIGS. 3 and 4, in the first embodiment the rotatable cutter (46) is enclosed and secured within the turnable collar (44). The turnable collar (44) is rotatable about the intermediate collar (40) which threadedly engages, shown by way of threads (61) at the dispensing end (20) of the hollow main body (12). The intermediate collar (40) includes a skirt (72) on which the corresponding internal skirt (75) of the turnable collar (44) can rotatably ride thereon.

Hence in this first embodiment shown in FIGS. 3 and 4, the fixed cutter (42) is fixed and the rotatable cutter (46) is turnable by the user to create the relative movement between the fixed cutter and the rotatable cutter as part of the overall cutting assembly.

A lock arrangement is shown generally as (50) which includes an extendable and retractable rod (83) which can be extended to pass through the aperture (84) of the intermediate collar (40) to engage with the slot (88) in the turnable collar (44). The slot (88) is limited in length and positioned such that extremes of rotation of the turnable collar (44) corresponds with the blades (63) of the fixed cutter (42) aligning with the blades (65) of the rotatable cutter (46). Before extruding the roll of pet food, the turnable collar (44) is turned to a first extreme to ensure that the blades are aligned to allow the pet food to pass through. Once the desired amount of pet food has been extruded the turnable collar is turned to the second extreme so that the blades pass through, and cut off, all of the extruded pet food.

In the first embodiment there is also a removable seal cap (48). Therefore in between servings the roll of pet food still remaining within the hollow main body (12) can be appropriately sealed, first by the cap (22) at the non-dispensing end (18) of the hollow main body (12) and then once the portion of food has been extruded out from the dispenser and the remaining roll of pet food within the hollow main body (12) is returned to storage such as in a refrigerator, the removable seal cap (48) can be applied accordingly.

For ease of usability a tab (81) has been included as part of the peripheral rim of the removable seal cap (48).

In first embodiments as shown in FIG. 3, a window (56) or other similar transparent covered slots or openings can provide a guide for showing how much product is remaining within the confines of the hollow main body (12).

Hence during application, the starting position would be the pressure plate (34) being wound up towards the non-dispensing end (18) within the hollow main body (12).

The roll of pet food, stripped of any of its covering film and/or packaging would then be inserted into the confines of the hollow main body (12) so that a first end of the roll of pet food would be pushed up and mounted against the pressure plate (34).

The user then engages the user-rotatable section (16) and by rotating the user-rotatable section (16) this then moves the pressure plate (34) down the rod (14) by way in the first embodiment because of the threaded inter-relationship between the pressure plate (34) and the rod (14).

As the pressure plate (34) is moving down the rod (14) it then forces the end of the roll of pet food to be extruded thereout from the pet food dispenser arrangement (10) in lengths defined by when the cutting assembly is actioned by the user.

Advantageously this invention does not simply allow the roll of pet food to be extruded out as continuous lengths.

The extruding of the pet food can be interrupted by a cutting action which can then cut the dispensed food up in to blocks by way of the relative movement between the blades (63) of the fixed cutter (42) and blades (65) of the rotatable cutter (44) which as introduced above in the first embodiment has the fixed cutter (42) mounted to the hollow main body (12) and the rotatable cutter (46) movable by the ability of the user to be able to rotate the turnable collar (44).

Advantageously you will also note from the illustrations that the user-rotatable section (16), cap (22), intermediate collar (40) and the turnable collar (44) all have user-friendly grasping edges that include scalloped indents for easy handling by a user.

Hence accordingly this invention provides for a very efficient way in which to be able to dispense pet food into individual blocks reducing preparation time and washing up thereafter and also a more convenient, safe and hygienic way in which to store the remaining roll of pet food in between servings.

The above described first embodiment includes two blades rotating with respect to each other, providing a cutting mechanism able to slice through considerably tough food. However, most pet food is of a consistency that can be sliced easily leading to a second embodiment of the invention, described below, containing a single cutter rotatably attached to the end of the main body.

The second embodiment of the invention is understood with reference to FIGS. 5 to 9. Familiarity of the description of the first embodiment of the invention will be assumed to avoid un-necessary repetition.

FIG. 5 shows a perspective view of a pet food dispenser (100) according to a second embodiment of the invention. The dispenser (100) comprises an elongate cylindrical body (105) formed from first half body (110) releasably attached to second half body (120) with the aid of handle (130) and clip (140). The dispenser includes a dispensing end (101) fitted with cap (150) and non-dispensing end (102) (with features mostly obscured in FIG. 5).

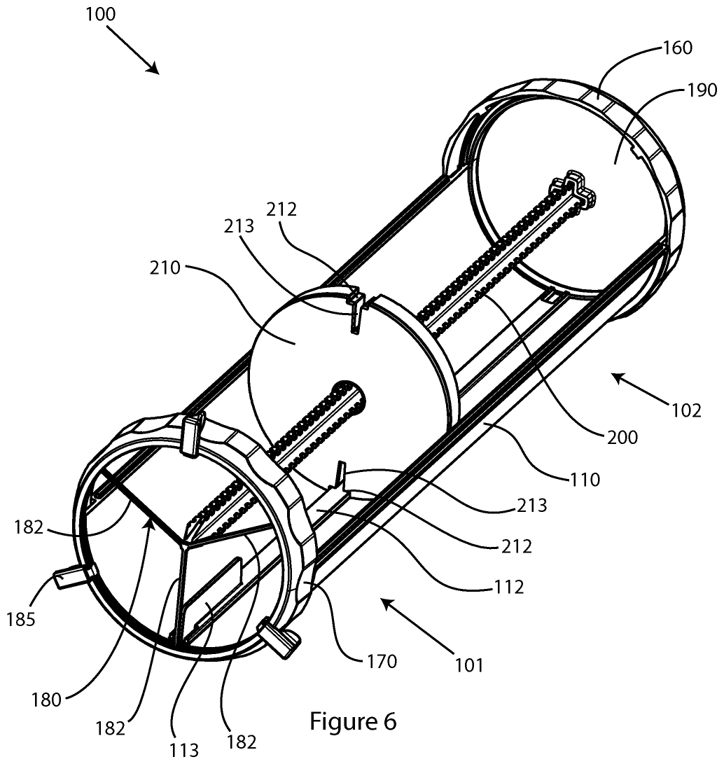

In FIG. 6 the end cap (150) and second body half (120) have been removed from the dispenser (100) to reveal its inner workings. Rotating end (190) is rotatably attached to the non-dispensing end (102) by collar (160). Rod (200) is attached to the rotating end (190), and threadedly engaged with pressure plate (210) such that the pressure plate(210) advances along the dispenser (100) as the rotating end (190) is rotated to extrude the pet food in the dispenser (100) through the cutter (180). Longitudinal rib (112) engages with notch (212) to ensure that pressure plate (210) advances along the dispenser (100) instead of rotating in unison with the rod (200). As the pet food passes through the cutter (180) it will be sliced longitudinally by the cutter's blades (182). Once the desired amount of pet food has passed through the cutter (180), the cutter (180) can be rotated with aid of cutter grips (185) so that the blades (182) cut off the extruded portion of the pet food. Vane (113) prevents undesired rotation of the pet food as the cutter (180) is rotated. Slot (213) provides clearance for vane (113) through the pressure plate (210).

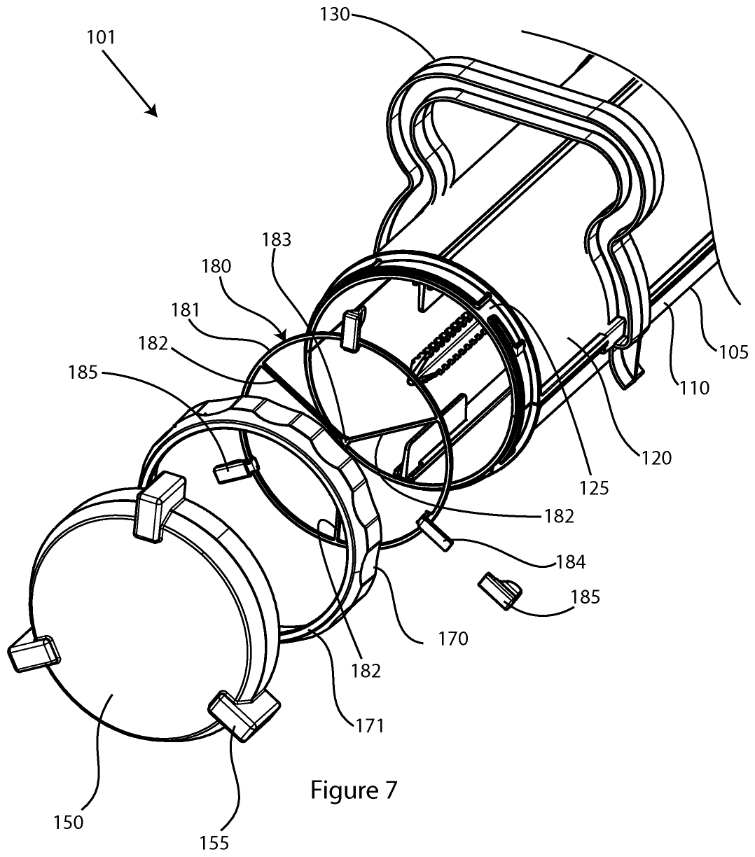

FIG. 7 shows an exploded view of the dispensing end (101) of the pet food dispenser (100). The dispensing end (101) includes the cutter (180) which is movably attached to the body (105) by collar (170). Removable cap (150) can be fitted over the collar (170) to seal the dispensing end (101) of the dispenser (100). The cutter (180) comprises a peripheral ring (181) supporting three blades (182) which join at hub (183). Tabs (184) are initially formed extending inwardly from the ring (180), allowing the cutter (180) to be placed inside the collar (170) against the inside of shoulder (171). The tabs (184) are then bent outwards and over the shoulder (171) and fitted with grips (185) that allow a user to rotate the cutter (180). The collar (170) is secured to the end of the body (105) by engaging nodules inside the collar (obscured) with raceway (125). The cutter (180) is secured between the end of the body (105) and the collar (170), which provide suitable clearances to allow the cutter (180) to freely rotate. Cap (150) engages the collar (170) with a slight interference fit. Grip covers (155) accommodate grips (185).

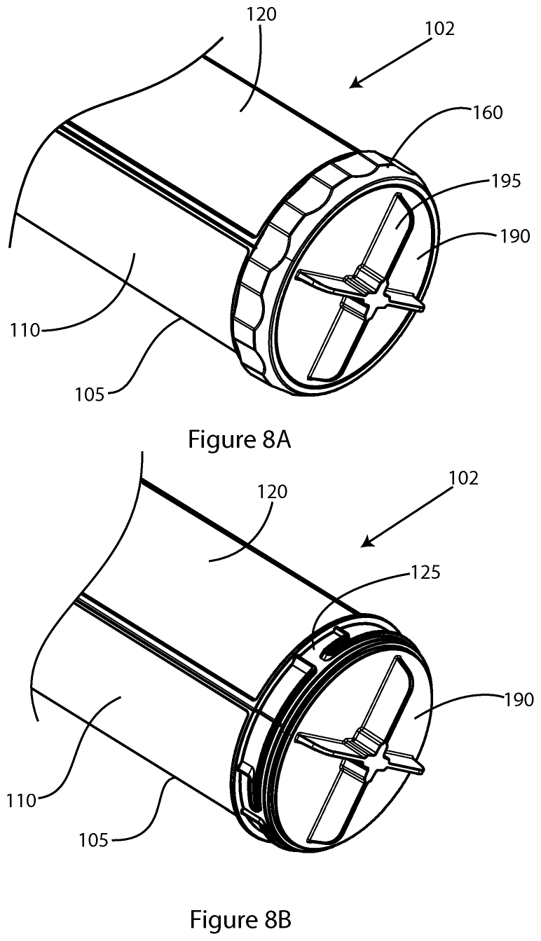

FIGS. 8A and 8B show the non-dispensing end (102) of the pet food dispenser (100). The rotating end (190) is rotatably attached to the end of the body (105) with the aid of collar (160) in a similar manner to how the collar (160) attaches the cutter (180) to the body (105). FIG. 8A shows the collar (160) fitted, whilst FIG. 8B shows the collar (160) removed to reveal raceway (125) which is used to engage the collar (160). End grips (195) facilitate the user rotating the rotating end (190).

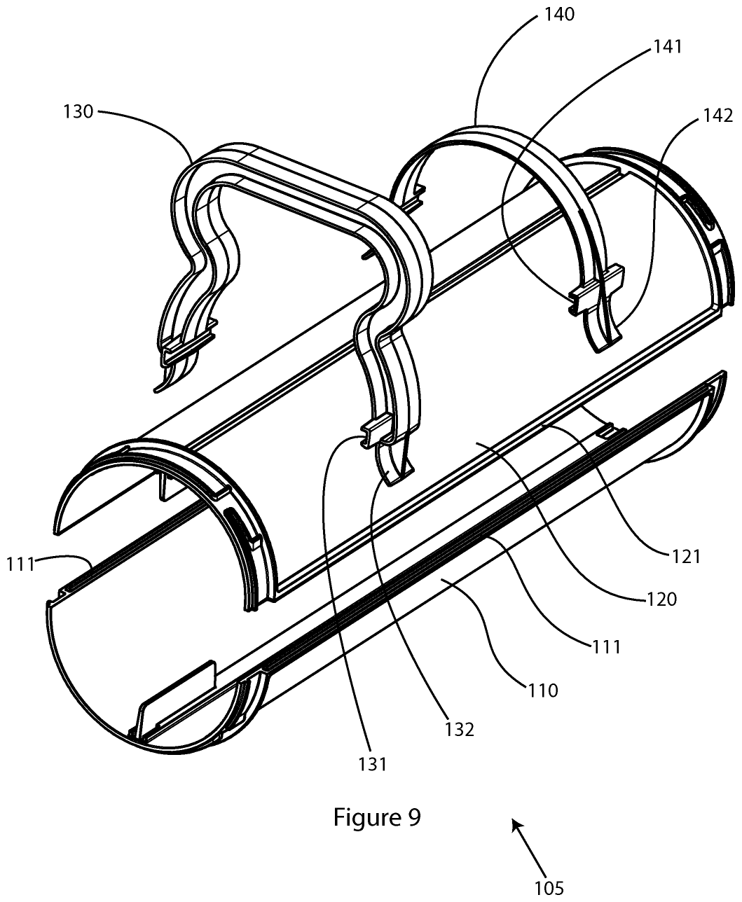

FIG. 9 shows an exploded view of the body (105). To assemble the body (105), first half body (110) is brought into contact with the second half body (120) along their respective flanges (111 and 121). The flanges include ribs to aid alignment. Once positioned together the two halves are secured together with the aid of channels (131) in the handle (130) and channels (141) in clips (140). Tabs (132) on the handle (130) and tabs (142) on the clip (140) facilitate removal of the handle (130) and clip (140). Being formed from two halves (110 and 120) the body (105) can be readily disassembled for thorough cleaning, and also provide an alternative method for placing pet food in the dispenser (100).

Whilst two embodiments of a pet food dispenser have been described, it is understood that other embodiments could also be created by selecting various combinations of features. For example, the window (56) of the first embodiment (10) could be incorporated into the second embodiment, or the split body (105) of the second embodiment incorporated into the first embodiment. Common to the embodiments is a rotatable end that extends a pressure plate to extrude the pet food through a cutter which is then rotated to cut off the pet food.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A pet food dispenser comprising a cylindrical body with a first dispensing end and a second non-dispensing end, a threaded rod extending from the dispensing end to the non-dispensing end and rotatably attached to the non-dispensing end, a pressure plate threadedly engaged with the rod, and a rotatable cutter including a peripheral ring supporting a plurality of blades attached to the dispensing end by a collar with inwardly disposed shoulders extending over the peripheral ring; wherein rotation of the rod moves the pressure plate along the rod pushing extruding the pet food through the rotatable cutter, and wherein rotation of the rotatable cutter cuts off the extruded pet food, and wherein the rotatable cutter is free to rotate within the collar and the rotatable cutter further comprises tabs extending from the peripheral ring and over the shoulders of the collar to allow a user to rotate the rotatable cutter and to retain the rotatable cutter within the collar when the rotatable cutter is detached from the dispenser body.

2. The pet food dispenser as in claim 1, wherein the cylindrical body is formed from first and second semi-cylindrical halves releasably attached together via elongate longitudinal flanges.

3. (canceled)

4. The pet food dispenser as in claim 2. Wherein the flanges comprise elongate longitudinal ridges.

5. The pet food dispenser as in claim 4, further comprising a handle with channels adapted to engage with the flanges to attach the flanges together.

6. The pet food dispenser as in claim 1, wherein the cylindrical body comprises at least one vane adapted to prevent rotation of the pet food within the cylindrical body.
